(19) United States
(12) Patent Application Publication
(10) Pub. No.: US 2016/0264379 A1
(43) Pub. Date: Sep. 15, 2016

(54) AUTOMATIC RESCUE APPARATUS FOR ELEVATOR

(71) Applicant: XIAMEN A.L.B.T. MACHINE EQUIPMENTS CO., LTD, XiaMen, Fujian (CN)

(72) Inventor: YaGuo ZHOU, Xiamen (CN)

(21) Appl. No.: 15/032,330

(22) PCT Filed: Nov. 6, 2014
(86) PCT No.: PCT/CN2014/090498

§ 371 Date: Apr. 27, 2016

(30) Foreign Application Priority Data
Nov. 13, 2013 (CN) 201310569797.2

(51) Int. Cl. B66B 5/02

(52) U.S. Cl. CPC B66B 5/027

(57) ABSTRACT

The below disclosed an automatic rescue apparatus for an elevator. The device is comprised of base (A), motor (11), input shaft (111), linkage gear (122), worm gear (12), worm screw (121), reduction gear set (13), bobbin line disk (14), and steel cable (2). The said Motor (11) connects to the input shaft (111) with thread segment (112) set up, and input shaft (111) is meshed with worm gear (12) through thread segment (112), while said worm gear (12) connects to the worm screw (121), and on the outer end of the worm screw (121) sets up linkage gear (122), meshed with the bull gear 131 of reduction gear set (13); besides, one end of the said bobbin line disk (14) is set up with gear (141), meshed with the pinion gear (132) of the reduction gear set (13), and bobbin line disk (14) is winded with steel cable (2) This device is with reasonable designing science, convenience and practicality which could make the elevator cars drop safely toward the elevator gate in the nearest floor during the malfunction, so the passengers could come out successfully.

### TECHNICAL FIELD

This invention relates to elevator field, especially involving to one type of elevator automatic rescue apparatus.

### BACKGROUND

Nowadays, thanks to domestic dense population, making all kinds of buildings built higher and higher with more and more floors, in order for the convenience of people climbing up and down the floors and easy access to the specific floor, all tall buildings generally set up elevators. And the common elevator equipment is to set up several cable wheels on the top of the elevator car. Winding over cable wheel, one end of the steel cable is set up firmly in the engine room to form a fixed end, while the other end is winded over the host motor in the engine room then went down to connect with a weight, therefore the steel cable which is driven by the host motor would pull the elevator car to move up and down.

Although such a lifting device could achieve the expected effect to send the passengers to where they want to go, during the actual operation, under the circumstances of power cut or malfunction that lead to the inability of elevator, the elevator would shut down urgently and stop lifting anymore in prevent of danger outcome. However, such design would make elevator car possibly to stop between floors, which causes the difficulty of rescue. Sometimes, due to the limitation of occasions, the elevator doors cannot successfully be forced to open for rescue. So the passengers have no choice but to wait inside until the power returns or the malfunction removed which could stop the elevator in front of the elevator gate in each floor, to save the passengers. This situation not only wastes passengers' waiting time, but also causes their psychological panic. Therefore, elevator still needs improvement and innovation to solve the current common problems.

### SUMMARY

The purpose of this invention is to provide a type of elevator automatic rescue apparatus which could make the elevator cars drop safely toward the elevator gate in the nearest floor during the malfunction, so the passengers could come out successfully.

Above-mentioned purpose of this invention would be achieved by the following technical scheme: elevator automatic rescue apparatus includes base, motor, input shaft, linkage gear, worm gear, worm, reduction gear set, bobbin line disk and steel cable. Above-mentioned motor connects input shaft with thread segment set up, and input shaft is meshed with worm gear through thread segment; while above-mentioned worm gear connects to the worm, and on the outer end of the worm sets up linkage gear, meshed with the bull gear of reduction gear set; besides, one end of the above-mentioned bobbin line disk is set up with gear, meshed with the pinion gear of the reduction gear set, and bobbin line disk is winded with steel cable.

Furthermore, the length of the above-mentioned steel cable is the same height of one floor.

Furthermore, elevator automatic rescue apparatus is fixed at the top of the elevator car, while the steel cable on the bobbin line disk would climb up to wind over the motor, then decline down to connect with weights.

Furthermore, elevator automatic rescue apparatus is fixed at the button of the elevator car, while the steel cable on the bobbin line disk would climb up to wind over the motor, then decline down to connect with weights.

Furthermore, elevator automatic rescue apparatus is fixed at the top of the elevator car; while the steel cable on the bobbin line disk would decline down to wind over the cable wheel which is designed for the button surface of the elevator car, then climb up to wind over to wind over the motor, then decline down to connect with weights.

Compared with the current technic, the beneficial effects of this invention are reasonable designing science, convenience and practicality which could make the elevator cars drop safely toward the elevator gate in the nearest floor during the malfunction, so the passengers could come out successfully.

### BRIEF DESCRIPTION OF THE DRAWINGS

FIG. 1 is the schematic diagram of three-dimensional disintegration structure of this invention;

FIG. 2 is the schematic diagram of partial enlargement structure of this invention;

FIG. 3 is the schematic diagram of three-dimensional composite of this invention;

FIG. 4 is the schematic diagram of front view structure of this invention;

FIG. 5 is the schematic diagram of the assembled state of this invention inside elevator equipment;

FIG. 6 is the schematic diagram of another assembled state of this invention inside elevator equipment;

FIG. 7 is the schematic diagram of another assembled state of this invention inside elevator equipment;

### SYMBOL DESCRIPTION OF THE MAIN COMPONENT

Elevator automatic rescue apparatus 1; Motor 11
Input shaft 111; Thread segment 112
Worm gear 12; Worm screw 121
Linkage gear 122; Reduction gear set 13
Bull gear 131; Pinion gear 132
Bobbin line disk 14; Gear 141
Steel cable 2; elevator car 3
Cable Wheel 31; Host Motor 4
Weights 5; Base A

### DETAILED DESCRIPTION

As below, this invention will be further described with the attached figure drawings and detailed Implement.

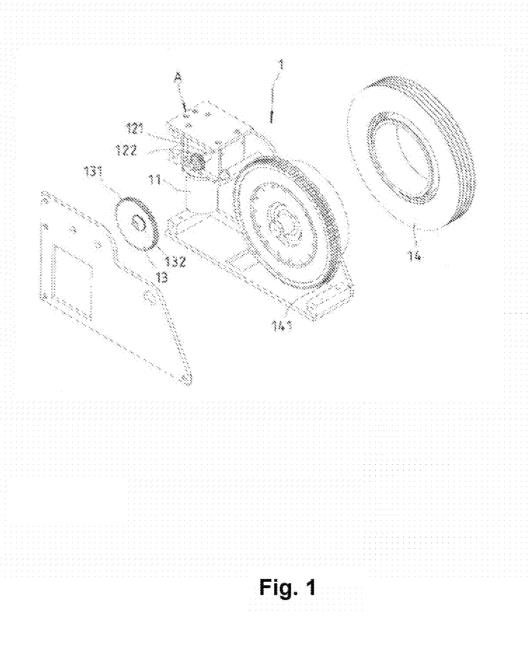

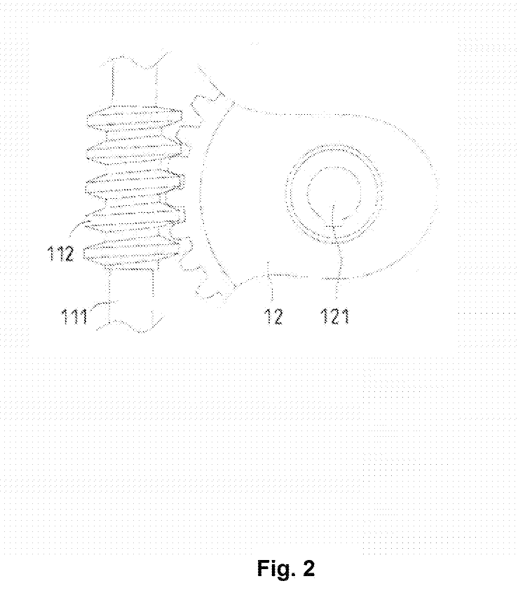

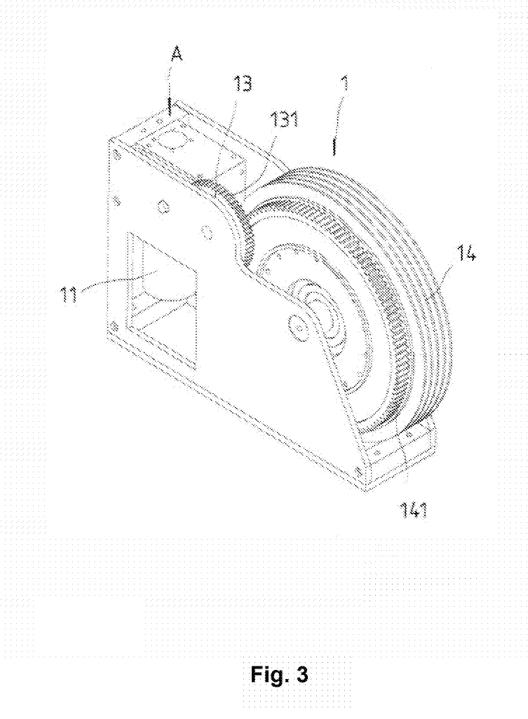

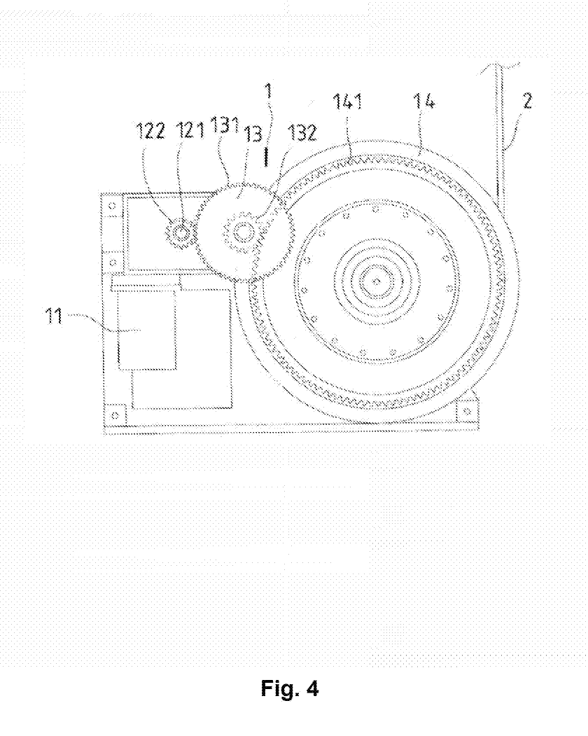

Example: elevator automatic rescue apparatus (1) as shown in FIG. 1, includes base (A), Motor (11), input shaft (111), linkage gear (122), worm gear (12), worm screw (121), reduction gear set (13), bobbin line disk (14) and steel cable (2). The above-mentioned Motor (11) connects to the input shaft (111) with thread segment (112) set up, and input shaft (111) is meshed with worm gear (12) through thread segment (112), as shown in FIG. 2, while above-mentioned worm gear (12) connects to the worm screw (121), and on the outer end of the worm screw (121) sets up linkage gear (122), meshed with the bull gear 131 of reduction gear set (13); besides, one end of the above-mentioned bobbin line disk (14) is set up with gear (141), meshed with the pinion gear (132) of the reduction gear set (13), and bobbin line disk (14) is winded with steel cable (2), as shown in FIGS. 3 and 4. Furthermore, the length of the above-mentioned steel cable (2) winding on bobbin line disk (14) is the same height of one floor.

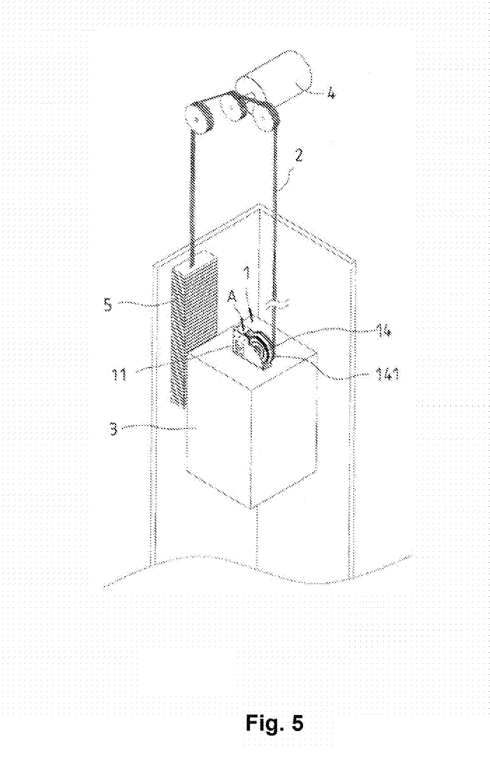

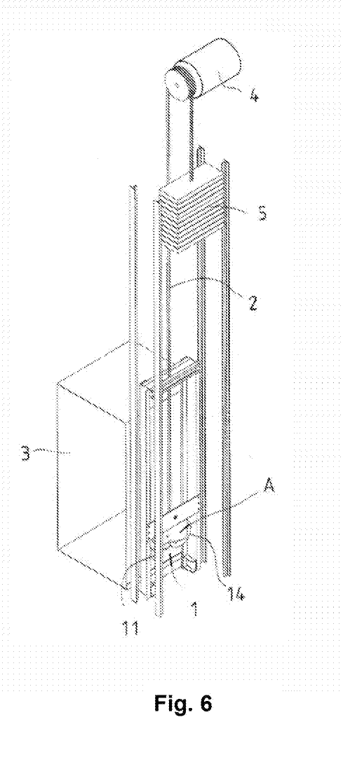

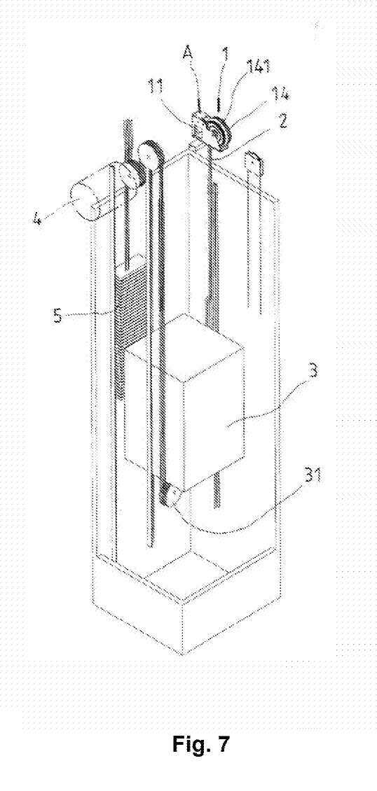

Under the combination of this invention and elevator, as shown in FIG. 5, elevator automatic rescue apparatus (1) is fixed at the top of the elevator car (3), while the steel cable (2) on the bobbin line disk (14) would climb up to wind over the host motor (4), then decline down to connect with weights (5). Or as shown in FIG. 6, elevator automatic rescue apparatus (1) is fixed at the button of the elevator car (3); while the steel cable (2) on the bobbin line disk (14) would climb up to wind over the host motor (4), then decline down to connect with weights (5). Also as shown in FIG. 7, elevator automatic rescue apparatus (1) is fixed at the top of the elevator equipment; while the steel cable (2) on the bobbin line disk (14) would decline down to wind over the cable wheel (31) which is designed for the button surface of the elevator car (3), then climb up to wind over to wind over the host motor (4), then decline down to connect with weights (5).

While the elevator is under normal operation, host motor (4) would arrange with weights (5) to roll and release the steel cable (2). At the meantime, the motor of elevator automatic rescue apparatus (1) is at state of rest, with braking force to bobbin line disk (14) and not happening to rotate from the gravity of the elevator car (3). Therefore, elevator automatic rescue apparatus (1) becomes as fixed end of steel cable (2) to assure the lifting of the elevator car (3) and the stopover in front of the elevator gate in each floor.

Under the circumstances of power cut or malfunction, host motor (4) would stop working, and elevator car (3) possibly stops between floors. Meanwhile, the motor of Elevator automatic rescue apparatus (1) would start to rotate and unfasten the braking status, which rotate bobbin line disk (14) to release all the winded steel cable (2). Set up between motor (11) and bobbin line disk (14), worm gear (12), worm screw (121), and reduction gear set (13) are for deceleration, which lets bobbin line disk (14) rotate slowly and the steel cable (2) on it put down slowly; therefore, elevator car (3) would drop toward the elevator gate in the nearest floor and be sensed by the sensor of elevator gate, which would stop the elevator car (3) to be forced to open successfully for the rescue of the passengers. After the return of the power or the clearing of malfunction, the motor (11) of elevator automatic rescue apparatus (1) could operate reversely, to make bobbin line disk (14) to roll steel cable (2) in the case of the again usage.

The above-mentioned detailed implement example is the preferred implement of this invention, for explanation only but not limitation. Within the principle and scope of this invention, the technical staff skilled in related technical field shall implement on different changes. Therefore, all equivalent technical solutions should also be within the scope of this invention.

1. An elevator automatic rescue apparatus (1) includes base, motor, input shaft, linkage gear, worm gear, worm screw, reduction gear set, bobbin line disk and steel cable; said motor connects input shaft with threaded segment set up, and input shaft is meshed with worm gear through threaded segment; while said worm gear connects to the worm screw, and on the outer end of the worm screw sets up linkage gear, meshed with the bull gear of reduction gear set; besides, one end of the said bobbin line disk is set up with gear, meshed with the pinion gear of the reduction gear set, and bobbin line disk is winded with steel cable.

2. The elevator automatic rescue apparatus (1) according to claim 1, wherein the length of the said steel cable is the same height of one floor.

3. The elevator automatic rescue apparatus (1) according to claim 1, wherein elevator automatic rescue apparatus (1) is fixed at the top of the elevator car, while the steel cable on the bobbin line disk would climb up to wind over the motor, then decline down to connect with weights.

4. The elevator automatic rescue apparatus (1) according to claim 1, wherein elevator automatic rescue apparatus (1) is fixed at the button of the elevator car, while the steel cable on the bobbin line disk would climb up to wind over the motor, then decline down to connect with weights.

5. The elevator automatic rescue apparatus (1) according to claim 1, wherein elevator automatic rescue apparatus (1) is fixed at the top of the elevator car; while the steel cable on the bobbin line disk would decline down to wind over the cable wheel which is designed for the button surface of the elevator car, then climb up to wind over to wind over the motor, then decline down to connect with weights.
